(19) United States
(12) Patent Application Publication
(10) Pub. No.: US 2011/0262686 A1
(43) Pub. Date: Oct. 27, 2011

(54) High Tensile Strength Article with Elastomeric Layer

(76) Inventors: Kathryn Wright, Katy, TX (US); Chandra Brown, Houston, TX (US)

(21) Appl. No.: 12/765,362

(22) Filed: Apr. 22, 2010

(51) Int. Cl. C08L 53/00; B32B 27/36; B32B 27/08; D04H 13/00; B32B 5/12

(52) U.S. Cl. 428/114; 525/70; 521/134; 442/327; 428/523; 521/139; 428/516; 428/483; 428/424.8

(57) ABSTRACT

The present invention is an article of a film or sheet or a laminate of the film or sheet with nonwoven facing layer(s). The film or sheet is a blended compound of selectively hydrogenated thermoplastic block copolymer, a tackifying resin, and polyolefin and/or polystyrene, that has superior tensile strength and a good balance of good elasticity, low stiffness and good adhesion.

### FIELD OF THE INVENTION

The present invention relates to an article having high tensile strength, a good balance of good elasticity, low stiffness and good adhesion. The article may simply be a film, fiber, foam, filament, plurality of filaments, nonwoven web, or sheet of an elastomeric compound, or a laminate formed by bonding an elastomeric compound layer in the form of a film, fiber, filament, plurality of filaments, foam, nonwoven web, or parallel strands to one or more facing layers. In particular, the present invention relates to an elastomeric compound having selectively hydrogenated thermoplastic block copolymer, cyclic aliphatic tackifying resin and polyolefin and/or polystyrene.

### BACKGROUND OF THE INVENTION

Various elastic composites formed from bonding an elastic polymer layer in the form of a film, foam, nonwoven web, or parallel strands to a nonwoven facing layer, are well-known and may be referred to as a stretch bonded laminate, a neck-bonded laminate, or a neck-stretch bonded laminate.

Elastic laminates are typically the most expensive components of personal care products such as diapers, diaper pants, adult incontinence garments, and the like. Elastic laminates that can be reproduced inexpensively but which have a good degree of elongation and sufficient recovery upon elongation in addition to stress relaxation with high tensile strength are highly desirable.

U.S. Pat. No. 6,916,750 to Thomas et al discloses an elastic polymer layer formed from styrene-(ethylene/butylene)-styrene-(ethylene/butylene) tetrablock copolymer, referred to as SEBSEB. An elastomeric layer can be formed from such a tetrablock alone, or blended into a compound by incorporation of one or more of polystyrene, polyolefin, or a tackifying resin. The elastic polymer layer is incorporated into the personal care products such as diapers, diaper pants and the like. While this product functions well, it is expensive.

U.S. Pat. No. 7,001,956 to Handlin, Jr. et al discloses articles prepared from monalkenyl arenes and conjugated dienes and blends of such copolymers with other polymers such as polyolefin and monoalkenyl arenes such as polystyrene. The articles for this patent are used in toys, shoe soles, gaskets, and grips. There is no disclosure to use such articles in personal care products. The block copolymers of this patent have comparatively weak tensile strength compared to the present invention.

U.S. Pat. No. 7,169,848 to Bening et al discloses a controlled distribution copolymer block of styrene with a midblock of conjugated diene and a monoalkenyl arene, and another end block of styrene. Midblocks having hydrogenated conjugated dienes with a center region that is rich in monoalkenyl arene units wherein there is a controlled distribution of the monoalkenyl arene units within the conjugated dienes and thus it discloses selectively hydrogenated controlled distribution S-EB/S-S thermoplastic block copolymers. These block copolymers are said to be useful in adhesives, such as pressure sensitive or hot melt adhesives.

Nevertheless, it is desirable to produce elastic articles having superior tensile strengths with a good balance of elasticity and low stiffness as well as good adhesion to one or more nonwoven webs or facings, or both, at a reduced cost, that are useful in personal care products. In particular an article of film 3 mil thick and 6 inch square has the required high tensile strength, defined as >6000 psi in the machine and/or transverse directions.

### SUMMARY OF THE INVENTION

The present invention is related to an article of manufacture which can simply be a film or sheet formed from an elastomeric compound, or a laminate formed from an elastomeric polymer compound in the form of a film, foam, nonwoven webs, or parallel strands to one or more facing layers to create a stretch bonded laminate, a neck bonded laminate, or neck-stretch bonded laminate, as disclosed in U.S. Pat. No. 6,916,750 mentioned above. International Patent WO 01/54900 A1 and U.S. Patent publication US2001/001685 A1 also disclose other methods to manufacture elastic laminates. The elastic article of the current invention is formed into a film, fiber, filament, plurality of filaments, or sheet from a blend of selectively hydrogenated thermoplastic block copolymer, cyclic aliphatic tackifying resin, and polyolefin and/or polystyrene wherein the article has a tensile strength of at least 6000 psi in the machine direction (MD) and/or the transverse direction (TD) with a 100% hysteresis permanent set of less than or equal to 6% in the MD and TD directions, and a 100% hysteresis recovered energy of ≧70% in the MD and TD directions, and a Probe Track (ASTM D 2979) of at least 0.110 Newtons. When a laminate article is formed with the elastomeric layer bound to one or more facing layers, these same properties are expected.

The present invention also relates to an article having high tensile strength, a good balance of low stiffness and recovery/set, good adhesion compound, comprising: from about 60 to about 80 wt. % selectively hydrogenated thermoplastic block copolymer; from about 17 to about 25 wt. % of cyclic aliphatic tackifying resin; from about 4-13 wt. % polyolefin; from about 0-15 wt. % polystyrene; having a tensile strength of at least 6000 psi in the MD and/or TD direction, (using about 4 wt. % polyolefin, 10 wt. % polystyrene, and 18 wt. % cyclic aliphatic tackifying resin, based on the compound—in an article of film 3 mil thick and 6 inch square).

The present invention also includes an article having high tensile strength and good adhesion compound, comprising: styrene block copolymer; cyclic aliphatic tackifying resin; having a tensile strength of at least 6000 psi in the MD and/or TD directions, (using about 12% polyolefin and 20 wt. % cyclic aliphatic tackifying resin, in an article of film 3 mil thick and 6 inch square); and a Probe Tack (ASTM D 2979) of at least 0.110 Newtons, and a 400% hysteresis permanent set of ≦30% in the MD and recovered energy ≧60% in the MD, and a stress relaxation of ≦32% after 4 hours, 100° F. at 50% elongation.

### BRIEF DESCRIPTION OF THE DRAWINGS

FIG. 1 is bar chart of % stress relaxation, after 4 hours, at 100° F. and 50% elongation for CompA and invention formulations 1-3.

FIG. 2 is a bar chart of the Polyken Probe Tack (in Newtons) for CompA and invention formulas 1-4.

### DESCRIPTION OF PREFERRED EMBODIMENTS

The article may simply be a film or sheet (including a foamed sheet), formed of a compound having components that are blended together, comprising a selectively hydrogenated thermoplastic block copolymer, tackifying resin, and polyolefin, optionally polystyrene, in proportions that have a tensile strength of 6000 psi in the MD and/or TD directions, and optionally a Probe Tack of at least 0.110 Newtons. The film or sheet formed from the compound can be melted extruded on a chill roll at a temperature and speed that determines the thickness of the film. Films 2 to 15 mils thick are known.

The article may also be a laminate Rained by bonding an elastomeric layer in the form of film, foam, nonwoven web or parallel strands, to one or more nonwoven facing layers. The elastomeric layer is formed from a compound of blended ingredients comprising hydrogenated thermoplastic block copolymer that can be linear or coupled-having-arms, a tackifying resin, and polyolefin and/or poly styrene in proportions that have a tensile strength of 6000 psi in the MD and/or TD directions, and optionally a Probe Tack of at least 0.110 Newtons.

The nonwoven facing layers may be formed using inelastic or elastic polymers. Suitable generally inelastic polymers include polyolefins such as homopolymers of ethylene, propylene or butylene and mixtures of these, including up to about 10% by weight alpha-olefin comonomers having up to about 12 carbon atoms. Also, inelastic polymers can include nylon, polyester, and polyurethane, etc. Suitable elastic polymers include copolymers of ethylene and butylene with an alpha olefin comonomer present in an amount greater than 10 wt. %, that have a density of between about 0.855 to about 0.910 g/cm³, and ethylene vinyl acetate, ethylene vinyl acrylate, ethylene methyl acrylate, etc.

The elastic layer and the nonwoven facing layer can be joined by melt extrusion of the elastic layer onto the nonwoven facing layer, as is well known to those skilled in the art. The two layers can also be joined by feeding each layer to a heated nip roll which heats both layers and presses them together. Lastly, the elastic layer and the nonwoven facing layer(s) can be glued together as is also known in the art, with a suitable adhesive.

As used herein, “thermoplastic block copolymer” is defined as a block copolymer having at least a first block of a mono alkenyl arene, such as styrene, and a second block of a polydiene, or a controlled distribution copolymer of diene and mono alkenyl arene. The method to prepare this thermoplastic block copolymer is via any of the methods generally known for block polymerizations. The present invention includes as an embodiment a thermoplastic copolymer composition, which may be either a linear tri-block copolymer, linear multi-block composition, or coupled radial copolymer. In the case of the di-block copolymer composition, one block is the alkenyl arene-based homopolymer block and polymerized therewith is a second block of polydiene or a controlled distribution copolymer of diene and alkenyl arene. In the case of the tri-block composition, it comprises, as end-blocks the glassy alkenyl arene-based homopolymer and a mid-block of polydiene or a controlled distribution copolymer of diene and alkenyl arene. Where a tri-block copolymer composition is prepared, the polydiene or controlled distribution diene/alkenyl arene copolymer can be herein designated as “B” and the alkenyl arene-based homopolymer designated as “A”. The A-B-A, tri-block compositions can be made by either sequential polymerization or coupling. In the sequential solution polymerization technique, the mono alkenyl arene is first introduced to produce the relatively hard aromatic block, followed by introduction of the controlled distribution diene/alkenyl arene mixture to form the mid block, and then followed by introduction of the mono alkenyl arene to form the terminal block. In addition to the linear, A-B-A configuration, the blocks can be structured to form a radial (branched) polymer, (A-B)ₙX or (A-B-A)ₙX, or both types of structures can be combined in a mixture. Some A-B diblock polymer can be present but preferably at least about 90 weight percent of the block copolymer is A-B-A or radial (or otherwise branched so as to have 2 or more terminal resinous blocks per molecule) so as to impart strength. Other structures include (A-B)ₙ and (A-B)ₙX. In the above formulas, n is an integer from 2 to about 4, preferably 2 to about 3, most preferably n is predominantly 2 and X is the remnant or residue of the coupling agent.

The method of making the controlled distribution thermoplastic block copolymers may be found in U.S. Pat. No. 7,169,848 to Bening et al and this reference is hereby incorporated by reference. Wherein prior to hydrogenation the styrene in the rubber block portion is copolymerized and incorporated in a controlled distribution having terminal regions that are rich in diene units (butadiene, isoprene, or a mixture thereof) and a center region that is rich in styrene units. Such polymers were hydrogenated under standard conditions such that greater than 95% of the diene double bonds in the rubbery block have been reduced. The process for producing a selectively hydrogenated styrene block copolymer is described in U.S. Pat. No. 7,169,848 to Bening et al. The controlled distribution block copolymer of the present invention may include the copolymer sold under the trade name Kraton A® by Kraton Polymers, Kraton A1536 and A1535 are examples.

The method of making the radial (branched) thermoplastic block copolymers may be found in U.S. Pat. Nos. 7,625,979 and 7,220,798 to Atwood et al and are hereby incorporated by reference. Basically, the method reacts a living lithium terminated polymer having the formula P-Li, where P is a copolymer chain of one or more conjugated dienes having 4 to 12 carbon atoms and one or more mono alkenyl arenes having from 8 to 18 carbon atoms, with an alkoxy silane coupling agent having the formula Rx-Si-(OR′)_{y} where x is 0 or 1, x+y=4, R and R′ are the same or different, R is selected from aryl hydrocarbon radicals, linear alkyl radicals, and branched alkyl hydrocarbon radicals, and R′ is selected from linear and branched alkyl hydrocarbon radicals, and where the molar ratio of Si to Li is from about 0.35 to about 0.7, thereby forming a coupled polymer. The alkoxy silane coupling agent is selected from tetramethoxy silane, tetraethoxy silane, tetrabutoxy silane, methyl trimethoxy silane, methyl triethoxy silane, isobutyl trimethoxy silane and phenyl trimethoxy silane. These references are hereby incorporated by reference.

It is also important to control the molecular weight of the various blocks. The preferred hydrogenated thermoplastic block copolymers may be of the A-B-A including but not limited to S-EB-S, S-EP-S, S-EP-S-EP, S-EB-S-EB, S-EB/S-S, or (A-B)nX including but not limited to (S-EB)ₙX, (S-EP)ₙX or (S-EB/S)ₙX wherein n is the number of arms and is preferably 2 to about 3, more preferably predominantly 2, and X is a coupling agent residue. In the above formulations, S means styrene, EB means ethylene-butadiene (manufactured by polymerization and hydrogenated of butadiene), and EP means ethylene-propylene (manufactured by polymerization and hydrogenated of isoprene). The amount of the selectively hydrogenated thermoplastic block copolymer (HSBC) is from about 60 to 80 wt. % of entire compound (elastomeric layer). The molecular weight of styrene employed in the A block is in a range from 5,000 to 12,000. The molecular weight of the B block in an A-B-A type employed is in a range from 50,000 to 100,000. The molecular weight of the B block in the (A-B)nX type employed is in a range from 25,000 to 50,000. The total average molecular weight for the triblock copolymer of the A-B-A of (A-B)₂X type is in the range of 55,000 to about 115,000. The weight percent of styrene in the selectively HSBC is 10% to about 45%. For the controlled distribution or B block the weight percent of mono alkenyl arene in each B block is between about 10 weight percent and about 75 weight percent, preferably between about 25 weight percent and about 50 weight percent. These molecular weights are most accurately determined by light scattering measurements, and are expressed as true number average molecular weights.

Another important aspect of the present invention is to control the microstructure or vinyl content of the conjugated diene in the controlled distribution copolymer block. The term “vinyl content” refers to the fact that a conjugated diene is polymerized via 1,2-addition (in the case of butadiene—it would be 3,4-addition in the case of isoprene). Although a pure “vinyl” group is formed only in the case of 1,2-addition polymerization of 1,3-butadiene, the effects of 3,4-addition polymerization of isoprene (and similar addition for other conjugated dienes) on the final properties of the block copolymer will be similar. The term “vinyl” refers to the presence of a pendant vinyl group on the polymer chain. When referring to the use of butadiene as the conjugated diene, it is preferred that about 20 to about 80 mol percent of the condensed butadiene units in the copolymer block have 1,2 vinyl configuration as determined by proton NMR analysis, preferably about 30 to about 80 mol percent of the condensed butadiene units should have 1,2-vinyl configuration. This is effectively controlled by varying the relative amount of the distribution agent. As will be appreciated, the distribution agent serves two purposes—it creates the controlled distribution of the mono alkenyl arene and conjugated diene, and also controls the microstructure of the conjugated diene. Suitable ratios of distribution agent to lithium are disclosed and taught in U.S. Pat. No. Re 27,145, which disclosure is incorporated by reference.

The block copolymer is selectively hydrogenated. Hydrogenation can be carried out via any of the several hydrogenation or selective hydrogenation processes known in the prior art. For example, such hydrogenation has been accomplished using methods such as those taught in, for example, U.S. Pat. Nos. 3,494,942; 3,634,594; 3,670,054; 3,700,633; and U.S. Reissue Pat. No. 27,145. Hydrogenation can be carried out under such conditions that at least about 90 percent of the conjugated diene double bonds have been reduced, and between zero and 10 percent of the arene double bonds have been reduced. Preferred ranges are at least about 95 percent of the conjugated diene double bonds reduced, and more preferably about 98 percent of the conjugated diene double bonds are reduced. Alternatively, it is possible to hydrogenate the polymer such that aromatic unsaturation is also reduced beyond the 10 percent level mentioned above. In that case, the double bonds of both the conjugated diene and arene may be reduced by 90 percent or more.

An important feature of the thermoplastic elastomeric copolymers of the present invention, including one or more polydiene block or controlled distribution diene/alkenyl arene copolymer blocks and one or more mono alkenyl arene blocks, is that they have at least two Tg's, the lower being the single Tg of the polydiene or controlled distribution copolymer block which is an intermediate of its constituent monomers Tg's. Such Tg is preferably at least above about −60° C. The second Tg, that of the mono alkenyl arene “glassy” block, is preferably more than about +80° C. The presence of the two Tg's, illustrative of the microphase separation of the blocks, contributes to the notable elasticity and strength of the material in a wide variety of applications, and its ease of processing and desirable melt-flow characteristics.

The elastomeric compound blend is comprised of one or more selectively hydrogenated thermoplastic block copolymers, cyclic aliphatic tackifying resin, olefin polymers, and/or styrene polymers.

Olefin polymers in the blended elastomeric compound include, for example, ethylene homopolymers, ethylene-alpha-olefin copolymers, propylene homopolymers, propylene-alpha-olefin copolymers, high impact polypropylene, polypropylene copolymers, propylene plastomers butylene homopolymers, butylenes-alpha-olefin copolymers, and other alpha-olefin copolymers or interpolymers. Representative polyolefins include, for example, but are not limited to, substantially linear ethylene polymers, homogeneously branched linear ethylene polymers, heterogeneously branched linear ethylene polymers, including linear low density polyethylene (LLDPE), ultra or very low density polyethylene (ULDPE or VLDPE), medium density polyethylene (MDPE), high density polyethylene (HDPE), high pressure low density polyethylene (LDPE), and polyethylene plastomers. Suitable polyolefin resins are sold under the trade name Epolene, Affinity, and Vistamaxx for example. The amount of olefin polymer employed is from about 4 to 13 wt. % based on the total weight of the elastomeric compound.

Styrene polymers include, for example, crystal polystyrene, high impact polystyrene, medium impact polystyrene, syndiotactic polystyrene, and styrene/olefin copolymers. Representative/olefin copolymers are substantially random ethylene/styrene or polypropylene-styrene copolymers, preferably containing at least 20 wt. % copolymerized styrene monomer. Suitable styrene polymers are sold under the trade names Styron and EA3710 for example. The amount of styrene polymer employed varies from about 0-15 wt. % based on the total weight of the elastomeric compound.

Cyclic aliphatic tackifying resins include polystyrene block compatible resins as well as polyolefin block compatible resins and midblock (rubbery block) compatible resins. The polystyrene block compatible resins, the polyolefin compatible resins, and the midblock compatible resins may be selected from the group consisting of compatible C₅ hydrocarbon resins, hydrogenated C₅ hydrocarbon resins, styrenated C₅ resins, C₅/C₉ resins, styrenated terpene resins, fully hydrogenated or partially hydrogenated C₉ hydrocarbon resins, rosin esters, rosin derivatives and mixtures thereof. Examples of these resins are sold under the trademarks Arkon and Oppera. The amount of cyclic aliphatic tackifying resin is from about 17 to about 25 wt. % of the total weight of the elastomeric compound.

The polymer blends of the present invention may be compounded further with other polymers, oils, fillers, reinforcements, antioxidants, stabilizers, fire retardants, anti-blocking agents, lubricants and other rubber and plastic compounding ingredients without departing from the scope of this invention. Stabilizers known in the art may also be incorporated into the composition. The stabilizers are for protection during the life of the finished product against, for example, oxygen, ozone and ultra-violet radiation. These may also be for stabilization against thermo-oxidative degradation during elevated temperature processing. Combinations of primary and secondary antioxidants may be used. Such combinations include sterically hindered phenolics with phosphites or thioethers, such as hydroxyphenylpropionates with aryl phosphates or thio ethers, or amino phenols with aryl phosphates. Specific examples of useful antioxidant combinations include, but are not limited to 3-(3,5-di-t-butyl-4-hydroxyphenyl)-propionate)methane (IRGANOX 1010, commercially available from BASF) with tris(nonyl-phenyl)phosphite (POLYGARD HR, commercially available from Uniroyal), IRGANOX 1010 with bis(2,4-di-t-butyl)pentaerythritol diphosphite (ULTRANOX 626, commercially available from Chemtura) and IRGANOX 1010 with dilauryl-3,3′-thiodiproprionate (DLTDP, commercially available from BASF). Antioxidants that act as bases generally should be avoided. IRGANOX, ULTRANOX and POLYGARD are trademarks. These other components are typically present in total between 1 and 2 wt. % of the total weight percent of the elastomeric compound. The compound may be prepared and immediately employed to make the article. However, if the compound is prepared and made into pellets for later use, it may be important to coat the pellets with a partitioning agent such as HDPE, silica, silane, and the like. Typically, the partitioning agent is employed around <1 w % of the compound weight. Of the amount employed depends on the ambient temperature, relative humidity, length of storage. Lastly, an example of various fillers that may be employed can be found in the 1971-1972 Modern Plastics Encyclopedia, page 240-247, which is hereby incorporated by reference.

The elastic layer is joined to one or two outer facing layers by extrusion melt bonding, thermal calendar bonding, adhesive, or other suitable process. The outer facing layers include a fibrous nonwoven material or a laminate including one or more fibrous nonwoven materials. Suitable nonwoven materials include spun bond webs, melt blown webs, bonded carted webs, air laid, dry laid, or wet laid webs, hydraulic entangled webs, or a range of substantially parallel and non-intersecting filaments. When two outer facing layers are employed, the layers may be the same or different. For example, an elastic layer may be extruded and cast on a chill drum and then brought into contact with endless supply of one or two outer layers and the layers are bonded by a pair of heated nip rolls. Likewise, the elastic layer may be melt extruded and extruded directly onto a nonwoven layer or extruded between two nonwoven layers which are brought together through a pair of calendar rolls, for example.

### Example 1

The formulation ingredients for Comparative A, WB-1, WB-2, WB-3, and WB-4 were dry blended. The material was manufactured on a 40 mm twin screw extruder. The material was processed with a temperature profile of 360-460 degrees Fahrenheit, at a screw speed of 300 rpm, generating a melt temperature ranging from 420-450° F. The manufactured product was converted to a 3 mil thick, 6 inch square film using a single screw extruder with a temperature profile of 390-450° F., at a screw speed of 34 rpm, generating a melt temperature of 447° F. The resulting elastic films were collected on a chill roll set to 41° F.

The compositions are set forth in Table 1. Polymer 1 is a coupled, hydrogenated styrene-ethylene/butadiene-styrene thermoplastic block copolymer with 19% styrene content and total molecular weight of 71,000 g/mol.

| | Comparative A | WB-1 | WB-2 | WB-3 | WB-4 |
|---|---|---|---|---|---|
| Ingredient | wt % | wt % | wt % | wt % | wt % |
| Polymer 1 | 68% | 68% | 68% | 68% | 68% |
| Epolene C-10 | 11.71% | 11.71% | 11.71% | | |
| Affinity GA1900 | | | | 11.71% | 11.71% |
| Regalrez 1126 | 19.85% | | | | |
| Arkon P125 | | 10.00% | | 10.00% | |
| Arkon P140 | | 9.85% | 19.85% | 9.85% | 19.85% |
| Ethanox 330 | 0.14% | 0.14% | 0.14% | 0.14% | 0.14% |
| Irgafos 168 | 0.30% | 0.30% | 0.30% | 0.30% | 0.30% |
| Microthene FA 709-00 | 0.55% | 0.55% | 0.55% | 0.55% | 0.55% |
| Total | 100.55% | 100.55% | 100.55% | 100.55% | 100.55% |

WB-1 thru WB-4 are reductions of the present invention. CompA is a comparative example based on Regalrez 1126 which is not a cyclic aliphatic tackifying resin but does have some desirable properties, but insufficient tensile strength. The films were tested for tensile and hysteresis properties. The results are set forth in Table 2. Tensile tests were performed using a dogbone configuration with a 1 inch gage length and a crosshead speed of 2 in/min. Hysteresis properties were tested to determine the elastic recovery characteristics of the article. During the hysteresis experiment, a ½ inch wide and 5 inch long strip is cut from the elastic film and elongated to either 100%, 300%, or 400% strain based on a 3 inch gage length at a crosshead speed of 10 in/min. After reaching the maximum strain, the specimen is immediately returned to 0 load also at a crosshead speed of 10 in/min. Following this cycle, the permanent set is calculated as the % strain at 0 load. Recovered energy is calculated at the area under the loading curve minus the area under the unloading curve divided by the area under the loading curve and is expressed in %. A perfect elastomer would exhibit a permanent set of 0% and a recovered energy of 100%. Stress relaxation was also measured using the same strip sample geometry where the sample is elongated to 50% strain and held for 4 hours at 100° F. The % stress relaxation is calculated as the peak stress minus the final stress divided by the peak stress. A perfect elastomer would exhibit 0% stress relaxation.

TABLE 2

| | CompA | WB-1 | WB-2 | WB-3 | WB--4 |
|---|---|---|---|---|---|
| Melt flow 200 C./5 kg | 9.5 | 9.6 | 9 | 9 | 9.5 |

Tensile Properties

| | | | | | | | | |
|---|---|---|---|---|---|---|---|---|
| Tensile strength | psi | MD | Avg | 5630 | 6920 | 7480 | 5600 | 6380 |
| | | | St Dev | 410 | 580 | 300 | 1100 | 450 |
| | | TD | Avg | 5310 | 6920 | 7460 | 6480 | 6140 |
| | | | St Dev | 950 | 1070 | 380 | 1650 | 690 |
| Elongation | % | MD | Avg | 860 | 800 | 790 | 840 | 880 |
| | | | St Dev | 4 | 40 | 30 | 70 | 10 |
| | | TD | Avg | 930 | 880 | 830 | 900 | 940 |
| | | | St Dev | 80 | 40 | 40 | 70 | 30 |
| Modulus 100% | psi | MD | Avg | 260 | 270 | 300 | 220 | 210 |
| | | | St Dev | 30 | 20 | 20 | 20 | 9 |
| | | TD | Avg | 230 | 250 | 300 | 210 | 200 |
| | | | St Dev | 10 | 10 | 10 | 10 | 5 |
| Modulus 300% | psi | MD | Avg | 460 | 520 | 570 | 410 | 400 |
| | | | St Dev | 40 | 60 | 40 | 40 | 20 |
| | | TD | Avg | 380 | 450 | 540 | 380 | 360 |
| | | | St Dev | 8 | 20 | 20 | 30 | 10 |
| Modulus 500% | psi | MD | Avg | 960 | 1300 | 1370 | 920 | 920 |
| | | | St Dev | 70 | 230 | 120 | 210 | 60 |
| | | TD | Avg | 700 | 970 | 1240 | 820 | 700 |
| | | | St Dev | 25 | 70 | 80 | 70 | 30 |

Cyclic hysteresis to 100% extension

| | | | | | | | | |
|---|---|---|---|---|---|---|---|---|
| Stress @ | psi | MD | Avg | 230 | 240 | 270 | 190 | 180 |
| 100% extension | | | St Dev | 10 | 20 | 10 | 10 | 20 |
| | | TD | Avg | 200 | 230 | 250 | 180 | 190 |
| | | | St Dev | 5 | 3 | 4 | 1 | 20 |
| Recoverable energy | % | MD | Avg | 80 | 80 | 80 | 80 | 80 |
| after 1 cycle | | | St Dev | 1 | 0.02 | 1 | 0.48 | 0.61 |
| | | TD | Avg | 80 | 80 | 80 | 80 | 80 |
| | | | St Dev | 0.29 | 0.33 | 0.12 | 0.04 | 0.67 |
| Hysteresis set @ | % | MD | Avg | 5 | 5 | 6 | 4 | 5 |
| 1 cycle | | | St Dev | 1 | 1 | 2 | 1 | 1 |
| | | TD | Avg | 5 | 6 | 5 | 5 | 6 |
| | | | St Dev | 1 | 0.16 | 1 | 0.46 | 2 |

Cyclic hysteresis to 400% extension

| | | | | | | | | |
|---|---|---|---|---|---|---|---|---|
| Loading Stress @ | psi | MD | Avg | 260 | 280 | 230 | 170 | 180 |
| 100% extension | | | St Dev | 20 | 20 | 30 | 20 | 9 |
| Unloading Stress @ | psi | MD | Avg | 90 | 100 | 90 | 90 | 90 |
| 100% extension | | | St Dev | 7 | 7 | 9 | 10 | 4 |
| Loading Stress @ | psi | MD | Avg | 330 | 350 | 290 | 220 | 240 |
| 200% extension | | | St Dev | 30 | 20 | 30 | 20 | 20 |
| Unloading Stress @ | psi | MD | Avg | 160 | 170 | 150 | 140 | 150 |
| 200% extension | | | St Dev | 10 | 10 | 20 | 20 | 9 |
| Loading Stress @ | psi | MD | Avg | 430 | 460 | 380 | 290 | 330 |
| 300% extension | | | St Dev | 40 | 30 | 40 | 30 | 20 |
| Unloading Stress @ | psi | MD | Avg | 260 | 280 | 240 | 210 | 230 |
| 300% extension | | | St Dev | 20 | 20 | 30 | 30 | 20 |
| Stress @ 400% | psi | MD | Avg | 600 | 650 | 550 | 420 | 460 |
| extension | | | St Dev | 50 | 50 | 70 | 50 | 40 |
| Recoverable energy | % | MD | Avg | 50 | 60 | 60 | 70 | 70 |
| after 1 cycle | | | St Dev | 0.71 | 0.17 | 1 | 1 | 0.37 |
| Hysteresis set @ | % | MD | Avg | 30 | 30 | 30 | 20 | 20 |
| 1 cycle | | | St Dev | 1 | 4 | 1 | 1 | 1 |

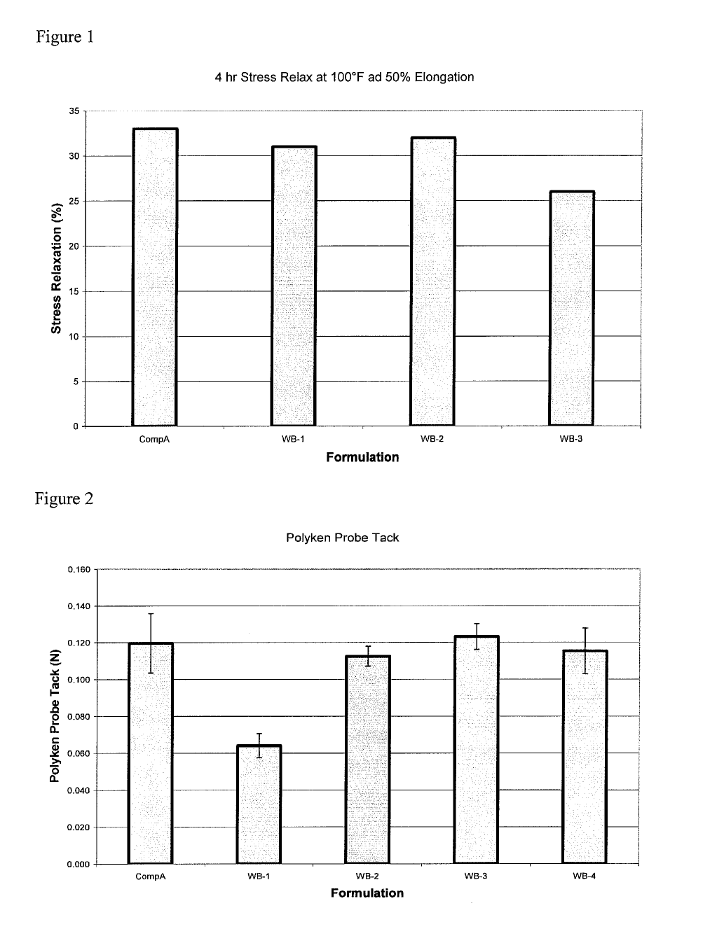

Formulations WB-1 thru WB-4 all have unexpectedly high tensile properties with low permanent sets associated with a cyclic extension to 100% and 400% strain. The formulations of the present invention also demonstrate high recovered energy after cyclic extension to 100% and 400% strain. The formulations of the present invention also demonstrate lower stress relaxation than CompA when exposed to 50% strain and 100° F. for 4 hours as shown in FIG. 1.

### Example 2

In addition to high tensile strength and good elasticity as described in Example 1, many applications also require a high level of tack to enhance adhesion of the an elastic laminate where layers or components in the elastic film or filaments of the present invention are laminated in physical contact with a polyolefin nonwoven. Surface tack has been measured via Polyken Probe Tack Testing according to ASTM D2979. The Polyken probe tack test measures the maximum force it takes to break the bond between a metal probe and an adhesive surface under controlled conditions. In this example, Polyken probe tack testing was measured using the following procedure:
Place the angular ring over a 2″×2″ film sample. After engaging the test apparatus, the test platform moves downward and maintains probe contact with the sample for a dwell time of 1 second. The test platform moves upward and the load cell will measure the peak tension force on the probe during the upward movement. Formulations WB-1, WB-2, WB-3, and WB-4 exhibit tack levels associated with the current invention. The results are shown in FIG. 2.

### Example 3

The formulation ingredients were dry blended. The material was manufactured on a 40 mm twin screw extruder. The material was processed with a temperature profile of 410-460 degrees Fahrenheit, at a screw speed of 300 rpm, generating a melt temperature of 454° F. The manufactured product was converted to a 3 mil thick, 6 inch wide film using a single screw extruder with a temperature profile of 380-450° F., at a screw speed of 34 rpm generating a melt temperature of 447° F. The resulting elastic films were collected on a chill roll set to 41° F.

| Formulation | KIC-09-012 |
|---|---|
| Kraton A 1536 | 67.50% |
| Arkon P125 | 9.00% |
| Arlon P140 | 9.00% |
| Affinty GA1900 | 4.25% |
| EA3400 PS | 10.00% |
| Ethanox 330 | 0.15% |
| Irgafos 168 | 0.15% |

This example demonstrates the specific combination of a selectively hydrogenated controlled distribution block copolymer (Kraton A1536) with cyclic aliphatic tackifying resins, a polyolefin plastomer and polystyrene. The final result is an elastic article demonstrating unexpectedly high tensile strengths in combination with good elastic performance as measured by the recovered energy and hysteresis set after exposure to a cyclic extension to 300% strain.

| | | | KIC-09-012 |
|---|---|---|---|
| Melt flow | 230 C./5 kg | | 15 |
| Tensile Properties | | | |
| Tensile Strength | psi | MD | 7160 |
| | | CD | 6450 |
| Ultimate Elongation | % | MD | 690 |
| | | CD | 800 |
| 100% Modulus, psi | psi | MD | 290 |
| | | CD | 190 |
| 300% Modulus, psi | psi | MD | 1000 |
| | | CD | 450 |
| 500% Modulus, psi | psi | MD | 3510 |
| | | CD | 1800 |
| Cyclic hysteresis to 300% extension | | | |
| Stress at 300% extension | psi | MD | 240 |
| | | CD | 150 |
| Recoverable energy after 1 cycle | % | MD | 70 |
| | | CD | 80 |
| Hysteresis set @ 1 cycle | % | MD | 6 |
| | | CD | 6 |

Thus it is apparent that there has been provided, in accordance with the invention, an article that fully satisfies the objects, aims, and advantages set forth herein. While the invention has been described in conjunction with specific embodiments thereof, it is evident that many alternatives, modifications, and variations will be apparent to those skilled in the art in light of the foregoing description. Accordingly, the invention is intended to embrace all such alternatives, and modifications and variations as fall within the spirit and broad scope of the intended claims.

What is claimed is:

1) An article having high tensile strength, a good balance of low stiffness and recovery/set, good adhesion compound, comprising: film, fiber, filament, plurality of filaments, foam, nonwoven web, parallel strands, or sheet of an elastomeric compound, or a laminate formed by bonding an elastomeric compound layer in the form of a film, fiber, filament, plurality of filaments, foam, nonwoven web, or parallel strands to one or more facing layers, said elastomeric compound comprising:
from about 60 to about 80 wt. % selectively hydrogenated thermoplastic block copolymer,
from about 17 to about 25 wt. % of cyclic aliphatic tackifying resin,
from about 4-13 wt. % polyolefin,
said article having a tensile strength of at least 6000 psi in the MD and/or TD direction, (using about 12% polyolefin and 20 wt. % cyclic aliphatic tackifying resin), and
a Probe Tack (ASTM D 2979) of at least 0.110 Newtons.

2) The article of claim 1, wherein said selectively hydrogenated thermoplastic block copolymer is S-EB-S, S-EP-S, S-EP-S-EP, S-EB-S-EB, or S-EB/S-S.

3) The article of claim 1, wherein said selectively hydrogenated thermoplastic block copolymer is (S-EB)nX, (S-EP)nX, and (S-EB/S)nX, where n is the number of wills and is 2-3 and X is a coupling agent residue.

4) The article of claim 1, wherein said polyolefin is substantially polyethylene based polyolefin plastomer.

5) The article of claim 1, wherein said polyolefin is substantially a polyethylene wax.

6) The article of claim 1, said elastomeric compound further including antioxidant, stabilizer and HDPE partitioning agent.

7) The article of claim 6, wherein the total amount of antioxidant, stabilizer and HDPE partitioning agent is less than 2 wt. % of said elastomeric compound.

8) The article of claim 1, wherein said article has 100% hysteresis permanent set ≦6% in the MD and TD directions, 100% hysteresis recovered energy ≧70% in the MD and TD directions,

9) The article of claim 1, wherein said article has a 400% hysteresis permanent set of ≦30% in the MD and recovered energy ≧60% in the MD.

10) The article of claim 1 wherein said facing layer or layers are comprised of homopolymers or copolymers of ethylene, propylene or butylene and mixtures of these, or and inelastic layer of nylon, polyester or polyurethane.

11) An article having high tensile strength, a good balance of low stiffness and recovery/set, good adhesion compound, comprising: film, fiber, filament, plurality of filaments, foam, nonwoven web, parallel strands, or sheet of an elastomeric compound, or a laminate formed by bonding an elastomeric compound layer in the form of a film, fiber, filament, plurality of filaments, foam, nonwoven web, or parallel strands to one or more facing layers, said elastomeric compound comprising:
from about 60 to about 80 wt. % selectively hydrogenated thermoplastic block copolymer,
from about 17 to about 25 wt. % of cyclic aliphatic tackifying resin,
from about 4-13 wt. % polyolefin,
from about 5-15 wt. % polystyrene,
said article having a tensile strength of at least 6000 psi in the MD and/or TD direction, (using about 4 wt. % polyolefin, 10 wt. % polystyrene, and 18 wt. % cyclic aliphatic tackifying resin).

12) The article of claim 11, wherein said selectively hydrogenated thermoplastic block copolymer is S-EB-S, S-EP-S, S-EP-S-EP, S-EB-S-EB, or S-EB/S-S.

13) The article of claim 11, wherein said selectively hydrogenated thermoplastic block copolymer is (S-EB)nX, (S-EP)nX, and (S-EB/S)nX, where n is the number of arms and is 2-3 and X is a coupling agent residue.

14) The article of claim 11, wherein said compound has a Probe Tack (ASTM D 2979) of at least 0.110 Newtons.

15) The article of claim 11, wherein said facing layer or layers are comprising homopolymers or copolymers of ethylene, propylene or butylene and mixtures of these, or and inelastic layer of nylon, polyester or polyurethane.

16) An article having high tensile strength and good adhesion compound, comprising: film, fiber, filament, plurality of filaments, foam, nonwoven web, parallel strands, or sheet of an elastomeric compound, or a laminate formed by bonding an elastomeric compound layer in the form of a film, fiber, filament, plurality of filaments, foam, nonwoven web, or parallel strands to one or more facing layers, said elastomeric compound comprising:
styrene block copolymer,
cyclic aliphatic tackifying resin,
polyolefin,
said article having a tensile strength of at least 6000 psi in the MD and/or TD direction, (using about 12 wt. % polyolefin and 20 wt. % cyclic aliphatic tackifying resin), and
a Probe Tack (ASTM D 2979) of at least 0.110 Newtons, and a 400% hysteresis permanent set of ≦30% in the MD and recovered energy ≧60% in the MD, and a stress relaxation of ≦32% after 4 hours, 100° F. at 50% elongation.

17) The article of claim 16, wherein said elastomeric compound has a 300% modulus of ≦450 psi in the MD and TD.

18) The article of claim 16, wherein said selectively hydrogenated thermoplastic block copolymer is S-EB-S, S-EP-S, S-EP-S-EP, or S-EB/S-S.

19) The article of claim 16, wherein said selectively hydrogenated thermoplastic block copolymer is (S-EB)nX, (S-EP)nX, and (S-EB/S)nX, where n is the number of arms and is 2-3 and X is a coupling agent residue.

20) The article of claim 16, wherein said polyolefin comprises 7 to 13 wt. % of said elastomeric compound.

21) The article of claim 16, wherein said elastomeric compound comprises 2 to 7 wt. % polyolefin and 5 to 15 wt. % polystyrene.

22) The article of claim 16, wherein said facing layer is an elastic layer of homopolymers or copolymers of ethylene, propylene or butylene and mixtures of these, or and inelastic layer of nylon, polyester or polyurethane.
